(19) United States
(12) Patent Application Publication
(10) Pub. No.: US 2003/0115694 A1
(43) Pub. Date: Jun. 26, 2003

(54) Toothbrush having a brushhead portion which contains a memory device for communicating with a microcontroller in a handle portion of the toothbrush or other device

(75) Inventor: John Pace, Bothell, WA (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/029,336

(22) Filed: Dec. 20, 2001

(51) Int. Cl. A61C 17/22

(52) U.S. Cl. 15/22.1; 132/310

(57) ABSTRACT

The toothbrush includes a brushhead portion having a bristle section in the vicinity of a distal end thereof. The toothbrush also includes a handle portion, with the brushhead portion being removable from the handle portion. The brushhead includes a memory element therein which contains identification information, in one embodiment, use information for the brushhead, while the handle portion includes a microcontroller which accumulates information concerning use of the brushhead. Electrical communication elements from the memory element and the microcontroller connect together when the brushhead is operatively in place on the handle, providing a data communication capability between the memory element and the microcontroller.

### TECHNICAL FIELD

This invention relates generally to toothbrushes having a brushhead portion which is removable from a handle portion thereof, and more specifically concerns such a toothbrush which includes a memory element in the brushhead identifying the brushhead and a microcontroller in the handle for storing information concerning use of the brushhead.

### BACKGROUND OF THE INVENTION

In electric power toothbrushes, it is well known to have a communication capability between the toothbrush and a separate control unit. Examples of such capability, among others, include U.S. Pat. No. 5,561,881, which is owned by the assignee of the present invention, and U.S. Pat. No. 5,337,435 to Krasner et al.

Information concerning the operation of the toothbrush can be accumulated and evaluated, including brushing pressure and time of use. Other useful information, such as duty time, can be calculated from the accumulated information. However, patents disclosing such a capability are directed toward communicating between a toothbrush per se and a separate control unit. The communication element in the toothbrush is located in the handle of the toothbrush. Such an arrangement cannot, however, provide information relative to the use of a particular brushhead from among a number of different brushheads which may be used with a particular handle. Hence, the information provided with such a conventional arrangement will not be brushhead-specific, so that replacement information will not be accurate for a particular brushhead. This could also be true for all other use-type information as well.

It would be desirable to be able to track identification and use information conveniently on a brushhead-by-brushhead basis.

### DISCLOSURE OF THE INVENTION

Accordingly, the present invention is a toothbrush which comprises: a brushhead portion having a bristle section in the vicinity of one end thereof; a handle portion, with a driver assembly therein for driving the bristle section, wherein the brushhead portion and the handle portion are adapted such that the brushhead portion is removable from the handle portion; a communication means for data communication between the brushhead portion and the handle portion when the brushhead portion and handle portion are joined together; a memory element in the brushhead portion for storing at least data which identifies the brushhead portion; and a microcontroller in the handle portion, wherein the memory element in the brushhead portion provides information therein to the microcontroller via the communication means.

### BRIEF DESCRIPTION OF THE DRAWINGS

FIG. 1 is a schematic view of the toothbrush of the present invention, showing the brushhead portion away from the handle portion.

FIG. 2 is an elevational view showing a brushhead storage apparatus.

FIG. 3 is a diagram showing the communication of information between the brushhead and the handle.

### BEST MODE FOR CARRYING OUT THE INVENTION

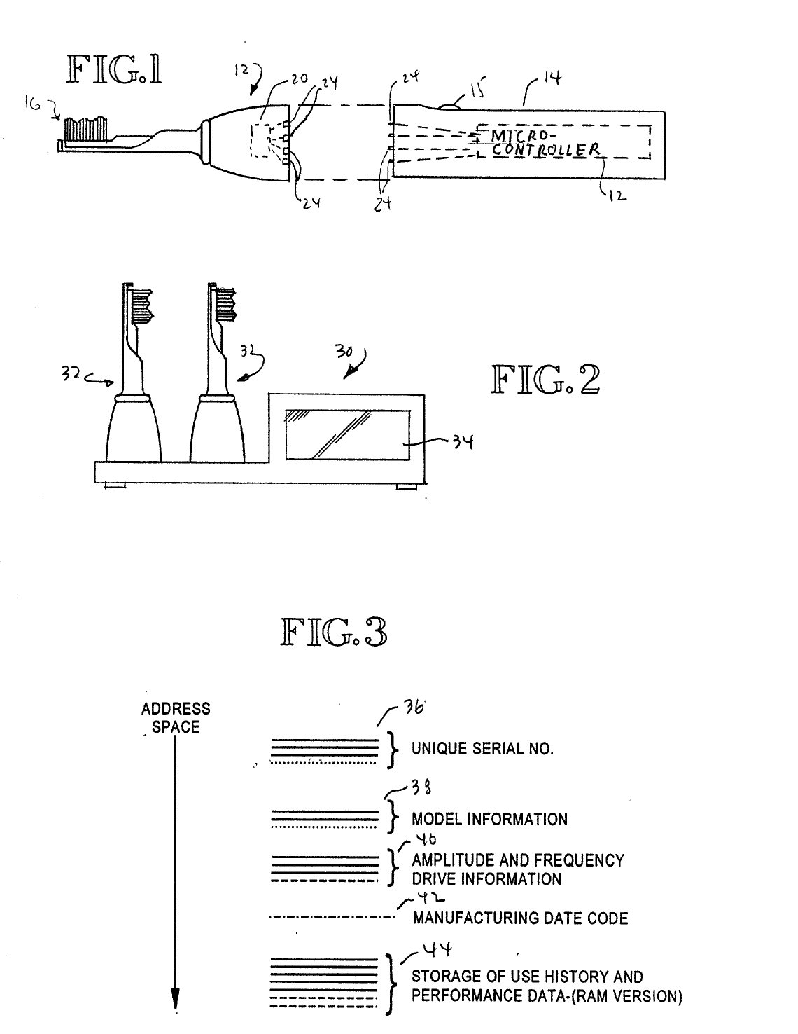

FIG. 1 shows a toothbrush generally at 10 which includes a brushhead portion 12 and a handle portion 14. Brushhead portion 12 includes a bristle assembly 16 at the distal end 18 of brushhead portion 12. Bristle assembly 16 includes a bristle base and a set of bristles mounted thereon. Brushhead portion 12 is conveniently removable from handle portion 14. This could be accomplished in a number of different structural ways, including a threaded connection, a snap-on connection or other similar type of mechanical connection. Handle portion 14 will typically include a motor/driver assembly (not shown), a rechargeable battery (not shown) and an on/off switch 15 for the toothbrush. Other driving arrangements, including a magnetic drive, however, could be used. While the toothbrush could be powered directly from the wall, battery power is typically preferable.

Located in brushhead portion 12 is a memory element 20, while the handle 14 includes a microcontroller 22. The brushhead portion and the handle portion both include electrically conductive elements 24-24 which provide a signal communication capability between them when brushhead 12 and the handle 14 are physically connected. There are, however, alternatives to conductive elements, such as infrared and other wireless type of communication. In particular, one likely type of wireless communication is inductive, using coils in both the brushhead and the handle.

In one embodiment, memory element 20 in the brushhead is a read-only memory (ROM) device, which is programmed with either a unique identification number for the brushhead or a substantially random number to identify the brushhead. The microcontroller 22 in the handle is capable of accumulating total use time or the total number of uses for a particular brushhead and has processing capability so that it can provide an indication to the user at a selected time when the brushhead should be replaced, e.g. after a selected number of uses. The present system can be used as an accurate, yet relatively simple and straightforward, brushhead replacement indicator. Timely brushhead replacement is automatically indicated to the user when a certain number of uses of the brush has been determined. This can be done by various audible (sounds) or visual methods, such as lights, on the toothbrush, or on a separate control or storage unit.

The accumulated use information in the microcontroller can be used in other ways. For instance, the pattern of use of a particular brushhead can be analyzed by dental professionals or others, such as the users themselves or parents of child users. Other information accumulated during use of the brushhead, such as brushing pressure, can be used to provide an indication of actual brushing performance.

The ROM device can also be programmed during manufacture of the brushhead with respect to particular characteristics of the brushhead, which can then be communicated to the microcontroller 22 in the handle when it is first installed therein. For example, a particular brushhead might be a children's model, and the information in the memory of the brushhead would identify it as such. This information would then be communicated to the microcontroller in the handle, which would then control the motor/driver to drive the brushhead at an appropriate amplitude for the child user, which would be typically lower than what adults would use.

Also, variations in the structure of the brushhead portion of the toothbrush, which result in variations in the moment of inertia or spring rate, identified during the manufacturing process, could be programmed into memory 20, so that the drive frequency for the toothbrush could be changed slightly by the microcontroller 22, in accordance with the information in the brushhead memory 20 to provide optimum overall performance for the toothbrush. The drive characteristics (amplitude and frequency) for the toothbrush could also be altered somewhat by the microcontroller to secure optimum performance for different brushheads used with the same handle.

In another embodiment, memory element 20 in the brushhead is a random access memory (RAM) device. In this embodiment, information can be provided (written) to the memory element 20, as well as read from the memory element, to the microcontroller or other device. In this embodiment, the total time of use as well as other information accumulated by the microcontroller can be communicated from the microcontroller 22 to the memory element 20 in the brushhead 12 and stored in the brushhead as opposed to being stored in handle 14. This not only reduces the memory required in the handle 14, but permits a brushhead to be used with different handles. The brushhead basically has the capability of a carrying its use information as well as its identifying information.

In addition to the ROM and RAM memory device embodiments, memory element 20 could be an electronic circuit which, upon a signal prompt, would transmit back an identifying signal/frequency which would serve to identify the brushhead. Also, memory element 20 could be other media capable of storing identifying data, including magnetic, all types of electronic and other media. The memory element 20 could also be part of an RFID chip. The term “memory element” or device used herein specifically includes such an electronic circuit, RFID chip with memory, magnetic media or other data storage media.

When there is substantial information stored in the brushhead, such as with the RAM embodiment, it is possible to have a readout in a brush storage device as to the identification of the brush, the time remaining before replacement, how often the brush is being used, or other information stored in the brushhead. This can be accomplished with a brushhead storage device 30 such as shown in FIG. 2. The brushhead storage device 30 can accommodate a plurality of different brushheads 32-32; for instance, different brushheads used by different members of a family. The brushhead storage device 30 will include a display element 34, with a read device, so that information in the memory element of each brushhead can be read and displayed by the storage device 30. The storage device will typically include a plurality of support elements for the individual brushheads, with electrical communication elements for connection between the brushheads and the display/reader 34.

Further, a display/reader apparatus could include a programming capability that would permit a dental professional, for instance, to customize the timing, the number of quadrants in a brushing operation, the amplitude of brush movement and/or a profile of amplitude v. time for particular patient needs/requirements.

The arrangement of the present invention, in which the brushhead contains a memory element with identifying information, could be used in a “lockout” mode, in which the driving element in the handle will not run unless a valid identification code is detected by the microcontroller from the brushhead. This would limit the use of the handle to only preselected brushheads.

As indicated above, signal communication is necessary between the memory element 20 in brushhead 12 and microcontroller 22 in handle 14. For a ROM device, only two connecting lines are necessary, while for a RAM device, four contacts (three are actually sufficient) provide the voltage, ground, data and read/write functions. In the embodiment shown, the connections are wire-type connectors. As indicated above, however, wireless connections, including inductive (with coils) and infrared, are also possible to provide the required signal communication.

FIG. 3 shows an example of information exchanged between the memory device 20 in the brushhead and the microcontroller 22 in the handle. For example, the information can include the identification of the brushhead in the form of a unique serial number as indicated at 36. Model information can be provided as shown at 38, while amplitude and frequency drive information can be provided, as shown at 40, as well as the manufacturing date code, as shown at 42. Use history and performance information which requires a RAM device is shown at 44. The information shown in FIG. 3 is illustrative only; other information arrangements can be used. The information should include identifying information of some kind relative to the brushhead.

With the RAM device, as indicated above, there is the potential of two-way communication between the microcontroller and the memory element in the brushhead, as well as between the memory element and an external programming/storage device. The information communicated could be brushhead identifying information in one direction and programming information in the other direction (from a programming device).

Accordingly, an intelligent brushhead has been developed which includes a memory element which is capable of storing selected information concerning the brushhead, such as an identification code. This information can be read to another device, such as a microcontroller in the toothbrush handle, through communication elements which extend from the memory element and connect to (or are inductively coupled to) similar communication elements which extend from the microcontroller, as illustrated in FIG. 1.

Although a preferred embodiment of the invention has been disclosed here for purposes of illustration, it should be understood that various changes, modifications and substitutions may be incorporated without departing from the spirit of the invention, which is defined by the claims which follow.

What is claimed is:

1. A toothbrush, comprising:
a brushhead portion having a bristle section in the vicinity of one end thereof;
a handle portion, with a driver assembly therein for driving the bristle section, wherein the brushhead portion and the handle portion are adapted such that the brushhead portion is removable from the handle portion;
communication means for data communication between the brushhead portion and the handle portion when the brushhead portion and handle portion are joined together;
a memory element in the brushhead portion for storing at least data which identifies the brushhead portion; and
a microcontroller in the handle portion, wherein the memory element in the brushhead portion provides information therein to the microcontroller via the communication means.

2. A toothbrush of claim 1, wherein the memory element is a read-only memory (ROM) device, and wherein the information stored in the memory includes an identification number associated with the brushhead, wherein the microcontroller in operation accumulates information concerning use of the brushhead, and wherein the apparatus includes means for reading the information in the memory element in the brushhead to the microcontroller.

3. A toothbrush of claim 1, wherein the memory element is a random access memory (RAM) device, and wherein information can be written to the RAM.

4. A toothbrush of claim 3, wherein the information is programming information for the operation of the toothbrush for the brushhead.

5. A toothbrush of claim 3, wherein the RAM can store information concerning use of the toothbrush.

6. A toothbrush of claim 1, wherein the toothbrush will not operate unless the information from the memory element is valid, as determined by the microcontroller.

7. A toothbrush of claim 1, including a brushhead storage element for temporarily storing a plurality of brushheads, wherein the brushhead storage element includes means for displaying selected information stored in the brushhead.

8. A toothbrush of claim 1, further including a programming device for providing programming information to a brushhead to define particular operations thereof.

9. A toothbrush of claim 1, wherein the communication means comprise electrically conductive elements, from the memory element and the microcontroller which interconnect as the brushhead is joined to the handle.

10. A toothbrush of claim 1, wherein the communication means comprise wireless components.

11. A toothbrush of claim 10, wherein the wireless components include coils on the brushhead and the handle for inductive communication.

12. A toothbrush of claim 10, wherein the wireless components include infrared transmission and receiver elements.

13. A toothbrush of claim 1, wherein the microcontroller includes means for comparing the actual use of the brushhead against a preselected use value and for providing an indication when the preselected value has been met, indicating that the brushhead should be replaced.

14. A brushhead portion of a toothbrush, the toothbrush including a handle portion to which the brushhead portion can be joined comprising:
a brushhead assembly which includes a bristle section, the brushhead assembly adapted to be removable from the handle portion of the toothbrush;
communication means for data communication between the brushhead assembly and a separate device; and
a memory element in the brushhead assembly for storing data identifying the brushhead assembly.

15. A brushhead of claim 14, wherein said separate device is the handle portion of the toothbrush.

16. A brushhead of claim 14, wherein the communication means includes means for data communication with the handle portion when the brushhead assembly and the handle are joined together.

17. A brushhead of claim 14, wherein the memory element is a read-only memory (ROM) device.

18. A brushhead of claim 14, wherein the memory element is a random access memory (RAM) device, wherein information can be written to the RAM.

19. A brushhead of claim 18, wherein the information is programming information for proper operation of the toothbrush relative to said brushhead assembly.

20. A brushhead of claim 14, wherein the communication means includes electrically conductive elements.

21. A brushhead of claim 15, wherein the communication means comprises wireless components.

22. A brushhead of claim 21, wherein the wireless components include coils for inductive communication.
